(19) United States
(12) Patent Application Publication
(10) Pub. No.: US 2023/0252798 A1
(43) Pub. Date: Aug. 10, 2023

(54) VEHICULAR VISION SYSTEM WITH FORWARD VIEWING CAMERA WITH SYNCHRONIZED RECORDING FEATURE

(71) Applicant: Magna Electronics Inc., Auburn Hills, MI (US)

(72) Inventor: Wilhelm Johann Wolfgang Wöhlte, Sailauf (DE)

(21) Appl. No.: 18/166,567

(22) Filed: Feb. 9, 2023

Related U.S. Application Data
(60) Provisional application No. 63/267,802, filed on Feb. 10, 2022.

(51) Int. Cl. G06V 20/58; H04L 12/40

(52) U.S. Cl. CPC G06V 20/58; H04L 12/40; H04L 2012/40215

(57) ABSTRACT

A vehicular vision system includes a camera disposed at a vehicle. The camera includes a first output interface and a second output interface. During operation of the camera, a first data stream is output by the camera via the first output interface and a second data stream is output by the camera via the second output interface. The first and second data streams are derived in part from video image data captured by the camera. The system includes a storage device remote from the camera that stores data received from the second data stream. The first data stream includes first synchronization data and the second data stream includes second synchronization data. The first synchronization data and the second synchronization data allow the first data stream and the second data stream to be temporally synchronized.

### CROSS REFERENCE TO RELATED APPLICATION

The present application claims the filing benefits of U.S. provisional application Ser. No. 63/267,802, filed Feb. 10, 2022, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

A driving assistance system or vision system or imaging system for a vehicle includes a camera disposed at a vehicle equipped with the vehicular vision system. The camera includes a CMOS imaging array, and the CMOS imaging array may include at least one million photosensors arranged in rows and columns. The camera is operable to capture video image data. The camera includes a first output interface and a second output interface. During operation of the camera, a first data stream is output by the camera via the first output interface and a second data stream is output by the camera via the second output interface. The first data stream and the second data stream are different. The first data stream is derived at least in part from video image data captured by the camera, and the second data stream is derived at least in part from video image data captured by the camera. The system includes an electronic control unit (ECU) with electronic circuitry and associated software. The electronic circuitry of the ECU includes a data processor for processing data of the first data stream for a driving assistance system of the vehicle. The second data stream is provided to a storage device that is remote from the camera, and the storage device stores data of the second data stream. The first data stream includes first synchronization data and the second data stream includes second synchronization data, and the first synchronization data and the second synchronization data allow the first data stream and the second data stream to be temporally synchronized.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras;

FIG. 2 is a schematic view of a known camera;

FIG. 3 is a schematic view of a camera with dual outputs for vehicle systems and image storage;

FIG. 4 is a schematic view of a vehicle with two cameras that do not synchronize data; and

FIG. 5 is a schematic view of a vehicle with a single camera that generates two outputs that are each synchronized.

### DESCRIPTION OF THE PREFERRED EMBODIMENTS

A vehicle vision system and/or driver or driving assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide display, such as a rearview display or a top down or bird's eye or surround view display or the like.

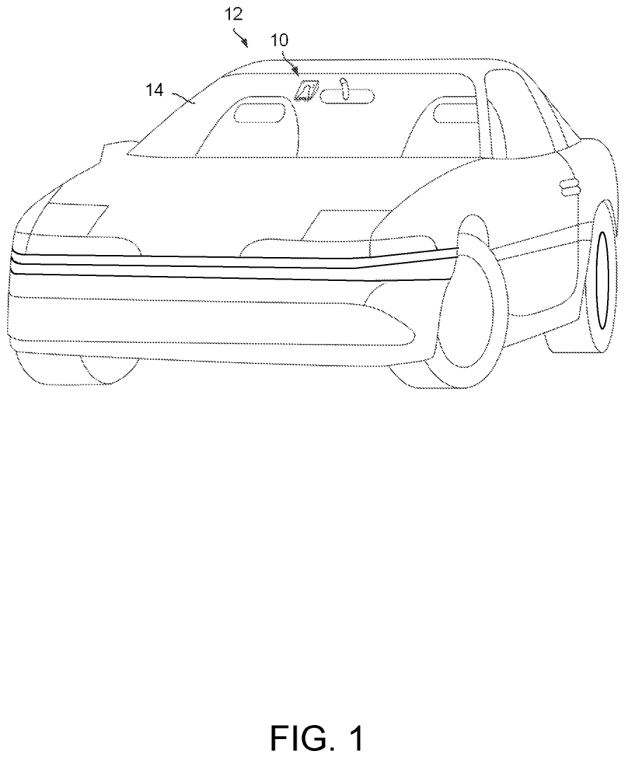

Referring now to the drawings and the illustrative embodiments depicted therein, a vision system 10 for a vehicle 12 includes at least one exterior viewing imaging sensor or camera, such as a forward viewing imaging sensor or camera, which may be disposed at and behind the windshield 14 of the vehicle and viewing forward through the windshield so as to capture image data representative of the scene occurring forward of the vehicle (FIG. 1). Optionally, the system may include multiple exterior viewing imaging sensors or cameras, such as a forward viewing camera at the front of the vehicle, and a sideward/rearward viewing camera at respective sides of the vehicle, and a rearward viewing camera at the rear of the vehicle, which capture images exterior of the vehicle. Optionally, the system includes one or more cameras that view interior of the vehicle, such as for a driver monitoring system (DMS) and/or for an occupant monitoring system (OMS). The camera or cameras each include a lens for focusing images at or onto an imaging array or imaging plane or imager of the camera. The forward viewing camera disposed at the windshield of the vehicle views through the windshield and forward of the vehicle, such as for a machine vision system (such as for traffic sign recognition, headlamp control, pedestrian detection, collision avoidance, lane marker detection and/or the like). The vision system 10 includes a control or electronic control unit (ECU) having electronic circuitry and associated software, with the electronic circuitry including a data processor or image processor that is operable to process image data captured by the camera or cameras, whereby the ECU may detect or determine presence of objects or the like and/or the system provide displayed images at a display device for viewing by the driver of the vehicle. The data transfer or signal communication from the camera to the ECU may comprise any suitable data or communication link, such as a vehicle network bus or the like of the equipped vehicle.

Implementations herein include a front facing or forward-viewing camera (e.g., a front camera module (FCM)) that has a field of view that at least partially includes an area in front of a vehicle equipped with the front facing camera that hosts or includes or executes machine vision functionality (e.g., traffic sign recognition) and also includes a logging interface for video recording. The camera combines traditional front camera features such as traffic sign recognition, lane keep assistance, object detection, and other advanced driving assistance systems (ADAS) and/or autonomous driving features based on machine vision algorithms with the ability to stream captured video data to an external storage.

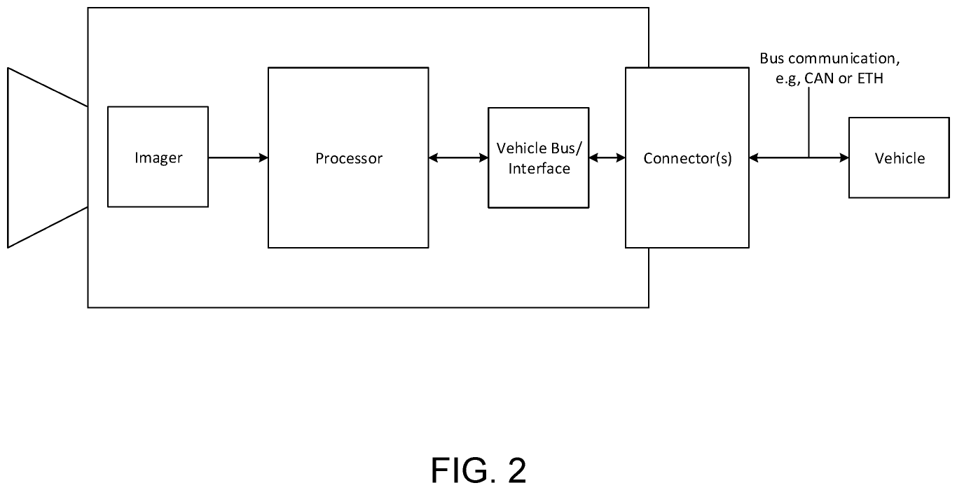

Referring now to FIG. 2, in conventional FCMs and/or other vehicular cameras, image data captured by the camera is only available on the vehicle data bus. For example, data captured and/or processed by the FCM is placed on the primary vehicle communication bus (e.g., a CAN or Ethernet bus). Bandwidth on this bus is commonly very valuable.

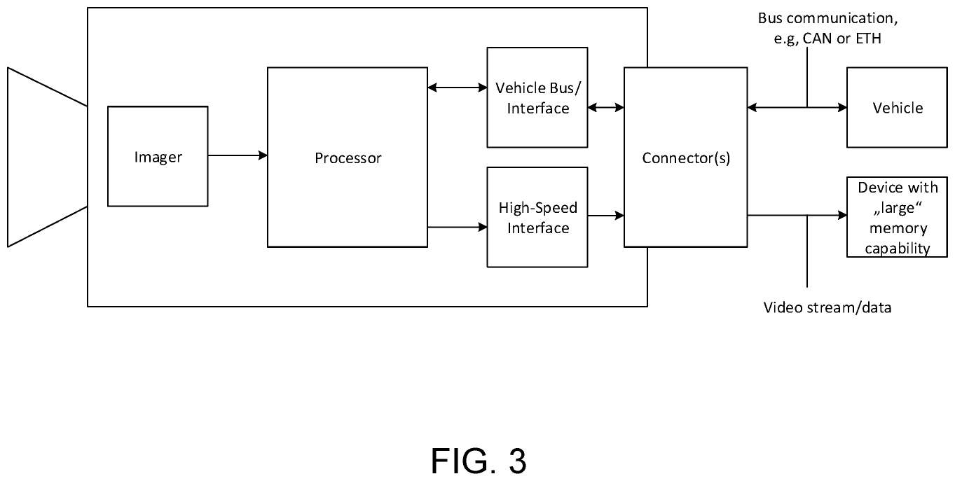

Referring now to FIG. 3, the system described herein may transmit image data captured by an image sensor (e.g., a camera of the FCM) to a processor (e.g., a system on a chip (SoC), an FPGA, a microprocessor, an ECU, etc.). The processor can run multiple machine vision (i.e., machine learning) algorithms on this video data for different use cases (e.g., object detection, lane centering, etc.). This video stream used for machine vision functionality may not be used for display to the driver (or other occupants of the vehicle) and instead may be purely processed by the processor for vehicle use. That is, image data processed by the camera and placed on the primary vehicle communication bus via a first connector may be used solely for “internal” vehicle use (e.g., for machine vision processing) and not displayed to occupants of the vehicle via a display disposed within the vehicle. The information extracted (e.g., by the processor) from the video stream or video image data may be reported over an interface to the vehicle, e.g., by using a CAN bus or Ethernet. The information may include any information relevant to driving assistance systems that may be extracted from image data, such as detected object lists (e.g., locations, velocities, classifications of various objects), lane marker information, traffic sign information, etc.

In parallel (i.e., simultaneously with transmitting the video image data to the processor for the machine vision functionality), the video image data may be additionally routed to a separate or secondary high-speed interface (e.g., an LVDS based interface) to be streamed out of the camera (FIG. 3). This second or separate video steam (i.e., separate from the video stream used for the machine vision functionality) may be stored in memory of a separate device (i.e., remote from the camera) in the vehicle (e.g., a domain controller or a head unit). Such a storage device may be equipped with large memory (i.e., nonvolatile memory) that has more space available relative to cameras. That is, because space in FCMs is often limited, it is not always possible or feasible or cost-effective to include large memory within the FCM and thus the camera is typically incapable of storing large amount of image data. In some examples, this image data provided by the camera via a second connector may be displayed to occupants of the vehicle (e.g., via one or more displays disposed within the vehicle).

The camera may include two separate connectors for outputting the two separate streams respectively. Optionally, the camera includes a single connector that is expanded to include enough connectors/pins to include both interfaces for transmitting both streams simultaneously (e.g., by increasing the pin-count of the single connector and ensuring that the electrical performance of the connector is compliant to the high-speed interface requirements).

Thus, image data captured by the camera can both be simultaneously processed at the camera for machine vision functionality and be recorded and stored at storage remote from the camera (e.g., at a head unit of the vehicle). The storage device may be located elsewhere in the vehicle (e.g., at the head unit) or remote from the vehicle (e.g., a cloud storage device in communication with the vehicle over the Internet via cellular wireless communication). The image data may later be retrieved for a variety of purposes (e.g., as evidence for collisions or other scenarios, for training machine learning models, etc.). The image data or video data sent to both the processor and to the storage may each include time stamps or other synchronization signals allowing or enabling synchronization of data across the two separate video streams. For example, the camera inserts corresponding synchronization signals into the same point of the two video streams of data such that, at a later point in time, the synchronization signals may be used to temporally correlate the two video streams.

Optionally, the FCM is assembled as one single-box that includes a lens for catching the light/information, one or more printed circuits boards (PCBs), supporting circuits such as power supplies, an image sensor, a processor (e.g., for executing algorithms), a vehicle interface such as CAN-FD or Ethernet for providing point cloud or similar information to the rest of the vehicle, and/or a high-speed data interface for streaming the video data or image data to the storage.

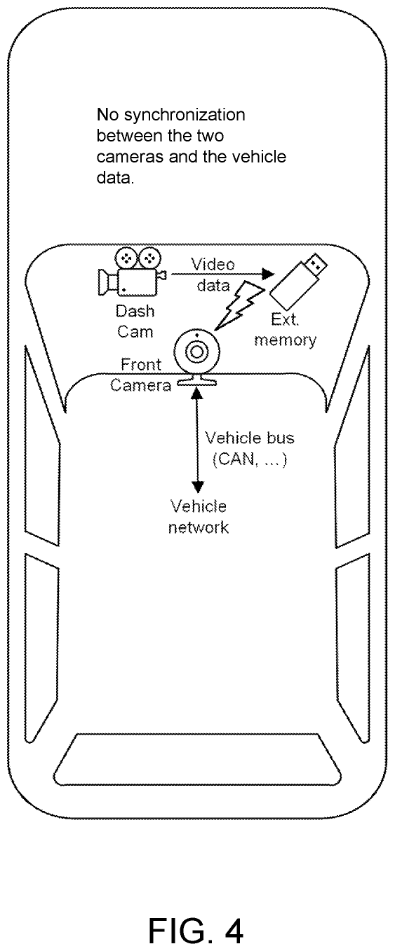

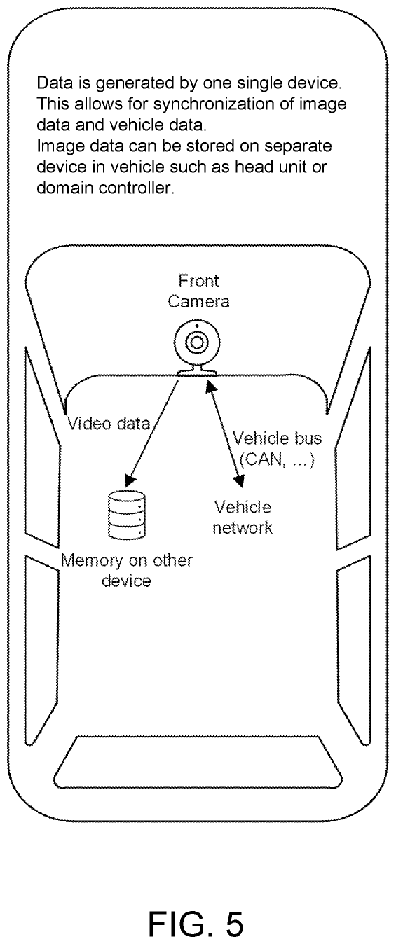

Thus, the vehicular vision system or vehicular driver assist system provides a camera that includes two simultaneous and independent outputs—a first output that outputs data (e.g., video image data, object lists, lane marker information, etc.) to a vehicle bus for use with various driver assistance systems or autonomous or semi-autonomous vehicle control systems and a second output that outputs video image data on a separate communication link for storage. The video image data output by the second output may be in a format suitable for storage (e.g., MPEG-4). Conventional FCMs fail to provide video image data as an output for data recording. Instead, such features are typically handled by “dash cams.” These dash cams are generally not automotive qualified aftermarket cameras. Thus, a direct link (i.e., synchronization) between video image data of dash cams and vehicle bus data from devices such as point clouds cannot be accomplished (FIG. 4). In contrast, the systems described herein provide for data recording (e.g., for collisions or other analysis) that is directly linkable (i.e., synchronizable) to communication/data on the vehicle bus (FIG. 5). Thus, analysis (e.g., for legal or insurance reasons, for training purposes, etc.) could synchronize vehicle events, such as braking, with images captured on the video. Both the video stream and vehicle bus protocol can be made available for analysis. For example, using the synchronization, images extracted from the stored video stream may be automatically annotated using the communication/data on the vehicle bus. The system may operate with any number or types of cameras, such as one or more exterior forward viewing cameras, one or more exterior rearward viewing cameras, one or more exterior sideward viewing cameras, and/or one or more interior viewing cameras (e.g., for a DMS and/or OMS).

Additionally, users of a vehicle do not need to install an additional camera (e.g., a dash cam) to acquire recording functionally, which reduces costs and increases windshield visibility. All relevant data is available in the car and its network/memories and thus no external device is necessary. Furthermore, there is no need for separate wiring in the cabin of the vehicle (i.e., for wiring the dash cam). Instead, any video cables are installed at, for example, a manufacturing plant of the vehicle. Additionally, data recording and capture during development would not require the usage of an extra logging tool. The system may utilize aspects of the camera described in U.S. Publication No. US-2020-0039448, which is hereby incorporated herein by reference in its entirety.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or pixels or at least three million photosensor elements or pixels or at least five million photosensor elements or pixels arranged in rows and columns. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The ECU may receive image data captured by a plurality of cameras of the vehicle, such as by a plurality of surround view system (SVS) cameras and a plurality of camera monitoring system (CMS) cameras and optionally one or more driver monitoring system (DMS) cameras. The ECU may comprise a central or single ECU that processes image data captured by the cameras for a plurality of driving assist functions and may provide display of different video images to a video display screen in the vehicle (such as at an interior rearview mirror assembly or at a central console or the like) for viewing by a driver of the vehicle. The system may utilize aspects of the systems described in U.S. Pat. Nos. 10,442,360 and/or 10,046,706, and/or U.S. Publication Nos. US-2021-0245662; US-2021-0162926; US-2021-0155167 and/or US-2019-0118717, and/or International Publication No. WO 2022/150826, which are all hereby incorporated herein by reference in their entireties.

The system may utilize aspects of driver monitoring systems and/or head and face direction and position tracking systems and/or eye tracking systems and/or gesture recognition systems. Such head and face direction and/or position tracking systems and/or eye tracking systems and/or gesture recognition systems may utilize aspects of the systems described in U.S. Pat. Nos. 11,518,401; 10,065,574; 10,017,114; 9,405,120 and/or 7,914,187, and/or U.S. Publication Nos. US-2022-0377219; US-2022-0254132; US-2022-0242438; US-2022-0111857; US-2021-0323473; US-2021-0291739; US-2020-0202151; US-2020-0143560; US-2020-0320320; US-2018-0231976; US-2018-0222414; US-2017-0274906; US-2017-0217367; US-2016-0209647; US-2016-0137126; US-2015-0352953; US-2015-0296135; US-2015-0294169; US-2015-0232030; US-2015-0092042; US-2015-0022664; US-2015-0015710; US-2015-0009010 and/or US-2014-0336876, and/or International Publication Nos. WO 2022/241423 and/or WO 2022/187805, and/or International PCT Application No. PCT/US2022/075887, filed Sep. 2, 2022 (Attorney Docket DON01 FP4586WO), which are all hereby incorporated herein by reference in their entireties.

Optionally, the vision system may include a display for displaying images captured by one or more of the imaging sensors for viewing by the driver of the vehicle while the driver is normally operating the vehicle. Optionally, for example, the vision system may include a video display device, such as by utilizing aspects of the video display systems described in U.S. Pat. Nos. 5,530,240; 6,329,925; 7,855,755; 7,626,749; 7,581,859; 7,446,650; 7,338,177; 7,274,501; 7,255,451; 7,195,381; 7,184,190; 5,668,663; 5,724,187; 6,690,268; 7,370,983; 7,329,013; 7,308,341; 7,289,037; 7,249,860; 7,004,593; 4,546,551; 5,699,044; 4,953,305; 5,576,687; 5,632,092; 5,708,410; 5,737,226; 5,802,727; 5,878,370; 6,087,953; 6,173,501; 6,222,460; 6,513,252 and/or 6,642,851, and/or U.S. Publication Nos. US-2014-0022390; US-2012-0162427; US-2006-0050018 and/or US-2006-0061008, which are all hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular vision system, the vehicular vision system comprising:
a camera disposed at a vehicle equipped with the vehicular vision system;
wherein the camera comprises a CMOS imaging array, and wherein the CMOS imaging array comprises at least one million photosensors arranged in rows and columns;
wherein the camera is operable to capture video image data;
wherein the camera comprises a first output interface and a second output interface, and wherein, during operation of the camera, a first data stream is output by the camera via the first output interface and a second data stream is output by the camera via the second output interface, and wherein the first data stream and the second data stream are different;
wherein the first data stream is derived at least in part from video image data captured by the camera, and wherein the second data stream is derived at least in part from video image data captured by the camera;
an electronic control unit (ECU) comprising electronic circuitry and associated software;
wherein the electronic circuitry of the ECU comprises a data processor for processing data of the first data stream for a driving assistance system of the vehicle;
wherein the second data stream is provided to a storage device that is remote from the camera, and wherein the storage device stores data of the second data stream; and
wherein the first data stream comprises first synchronization data and the second data stream comprises second synchronization data, and wherein the first synchronization data and the second synchronization data allow the first data stream and the second data stream to be temporally synchronized.

2. The vehicular vision system of claim 1, wherein the first synchronization data and the second synchronization data comprise timestamps.

3. The vehicular vision system of claim 1, wherein the camera views exterior of the vehicle.

4. The vehicular vision system of claim 3, wherein the camera is disposed at an in-cabin side of a windshield of the vehicle and views forward of the vehicle through the windshield.

5. The vehicular vision system of claim 1, wherein the second data stream comprises video image data captured by the camera, and wherein the storage device stores the video image data of the second data stream.

6. The vehicular vision system of claim 1, wherein the first output interface comprises a controller area network (CAN) bus interface.

7. The vehicular vision system of claim 1, wherein the second output interface comprises an Ethernet interface.

8. The vehicular vision system of claim 1, wherein the storage device receives the second data stream via low voltage differential signaling (LVDS).

9. The vehicular vision system of claim 1, wherein the storage device is disposed at a head unit of the vehicle.

10. The vehicular vision system of claim 1, wherein the storage device is remote from the vehicle and the second data stream is wirelessly communicated to the storage device.

11. The vehicular vision system of claim 10, wherein the storage device comprises a cloud storage device.

12. The vehicular vision system of claim 1, wherein the camera outputs the first data stream via the first output interface using a first electrical connector, and wherein the camera outputs the second data stream via the second output interface using a second electrical connector, and wherein the first electrical connector and the second electrical connector are different.

13. The vehicular vision system of claim 1, wherein the camera outputs the first data stream via the first output interface and the second data stream via the second output interface simultaneously using a single electrical connector.

14. The vehicular vision system of claim 1, wherein the camera comprises the ECU.

15. The vehicular vision system of claim 1, wherein the first data stream comprises point cloud information.

16. A vehicular vision system, the vehicular vision system comprising:
a camera disposed at a vehicle equipped with the vehicular vision system, wherein the camera is disposed at an in-cabin side of a windshield of the vehicle and views forward of the vehicle through the windshield;
wherein the camera comprises a CMOS imaging array, and wherein the CMOS imaging array comprises at least one million photosensors arranged in rows and columns;
wherein the camera is operable to capture video image data;
wherein the camera comprises a first output interface and a second output interface, and wherein, during operation of the camera, a first data stream is output by the camera via the first output interface and a second data stream is output by the camera via the second output interface, and wherein the first data stream and the second data stream are different;
wherein the first data stream is derived at least in part from video image data captured by the camera, and wherein the second data stream is derived at least in part from video image data captured by the camera;
an electronic control unit (ECU) comprising electronic circuitry and associated software;
wherein the electronic circuitry of the ECU comprises a data processor for processing data of the first data stream for a driving assistance system of the vehicle;
wherein the second data stream is provided to a storage device that is remote from the camera, and wherein the storage device stores data of the second data stream; and
wherein the first data stream comprises first synchronization data and the second data stream comprises second synchronization data, and wherein the first synchronization data and the second synchronization data allow the first data stream and the second data stream to be temporally synchronized, and wherein the first synchronization data and the second synchronization data comprise timestamps.

17. The vehicular vision system of claim 16, wherein the second data stream comprises video image data captured by the camera, and wherein the storage device stores the video image data of the second data stream.

18. The vehicular vision system of claim 16, wherein the first output interface comprises a controller area network (CAN) bus interface.

19. The vehicular vision system of claim 16, wherein the second output interface comprises an Ethernet interface.

20. A vehicular vision system, the vehicular vision system comprising:
a camera disposed at a vehicle equipped with the vehicular vision system;
wherein the camera comprises a CMOS imaging array, and wherein the CMOS imaging array comprises at least one million photosensors arranged in rows and columns;
wherein the camera is operable to capture video image data;
wherein the camera comprises a first output interface and a second output interface, and wherein, during operation of the camera, a first data stream is output by the camera via the first output interface and a second data stream is output by the camera via the second output interface, and wherein the first data stream and the second data stream are different;
wherein the first data stream is derived at least in part from video image data captured by the camera, and wherein the second data stream is derived at least in part from video image data captured by the camera;
wherein the camera comprises an electronic control unit (ECU), and wherein the ECU comprises electronic circuitry and associated software;
wherein the electronic circuitry of the ECU comprises a data processor for processing data of the first data stream for a driving assistance system of the vehicle;
wherein the second data stream is provided to a storage device within a head unit of the vehicle that is remote from the camera, and wherein the storage device stores data of the second data stream; and
wherein the first data stream comprises first synchronization data and the second data stream comprises second synchronization data, and wherein the first synchronization data and the second synchronization data allow the first data stream and the second data stream to be temporally synchronized.

21. The vehicular vision system of claim 20, wherein the first synchronization data and the second synchronization data comprise timestamps.

22. The vehicular vision system of claim 20, wherein the camera outputs the first data stream via the first output interface using a first electrical connector, and wherein the camera outputs the second data stream via the second output interface using a second electrical connector, and wherein the first electrical connector and the second electrical connector are different.

23. The vehicular vision system of claim 20, wherein the camera outputs the first data stream via the first output interface and the second data stream via the second output interface simultaneously using a single electrical connector.

24. The vehicular vision system of claim 20, wherein the first data stream comprises point cloud information.
